(19) United States
(12) Patent Application Publication
(10) Pub. No.: US 2026/0246120 A1
(43) Pub. Date: Aug. 20, 2026

(54) ELECTRODE ASSEMBLY AND METHOD OF MANUFACTURING THE SAME

(71) Applicant: SK On Co., Ltd., Seoul (KR)

(72) Inventors: Jae Ho LEE, Daejeon (KR); Won Joon JANG, Daejeon (KR); Gun Young KIM, Daejeon (KR)

(21) Appl. No.: 19/543,878

(22) Filed: Feb. 19, 2026

(30) Foreign Application Priority Data
Feb. 19, 2025 (KR) 10-2025-0021378

(51) Int. Cl. H01M 50/586; H01M 50/54

(52) U.S. Cl. CPC H01M 50/586; H01M 50/54

(57) ABSTRACT

The present disclosure relates to an electrode assembly and a method of manufacturing the same, and more specifically, to an electrode assembly in which a plurality of electrode plates each including an uncoated portion and a coated portion and a plurality of separators are alternately stacked and which includes a plurality of tabs each protruding to one or both sides from the uncoated portion, wherein the plurality of tabs are aligned to overlap each other to form a converging tab bundle, and the tab bundle includes a gel cured portion, and a manufacturing method to manufacture the same.

### CROSS-REFERENCE TO RELATED PATENT APPLICATION

The present application claims priority under 35 U.S.C. § 119(a) to Korean patent application number 10-2025-0021378 filed on February 19, 2025, in the Ministry of Intellectual Property, the entire disclosure of which is incorporated by reference herein.

### BACKGROUND OF THE INVENTION

### Field

The present disclosure relates to an electrode assembly capable of improving quality of electrodes in a secondary battery and a method of manufacturing the same.

### Description of the Related Art

The demand for eco-friendly alternative energy sources is becoming an indispensable factor for future life as the price of energy sources is increasing due to the depletion of fossil fuels and environmental pollution is becoming a growing concern, and the demand for secondary batteries as an energy source is soaring rapidly due to the technology development and the increasing demand for mobile devices.

Among the various types of secondary batteries, lithium secondary batteries are typically manufactured, with an electrode assembly, in which a cathode, a separator, and an anode are stacked, mounted in a case, and lithium ions undergo repetitive intercalation and deintercalation from lithium metal oxide of the cathode to the anode, which leads to charging and discharging of the lithium secondary battery.

For example, an electrode assembly generally has a three-layer structure of cathode/separator/anode, a five-layer structure of cathode/separator/anode/separator/cathode or anode/separator/cathode/separator/anode, or a structure with more layers stacked in a predetermined number of unit cells so as to form a single electrode assembly. Further, the electrode assembly may be housed in a case, such as a cylindrical can, an angular pouch, or the like.

On the other hand, one of the most important factors in the studies of secondary batteries is to improve safety while increasing capacity. Due to various factors, secondary batteries are prone to ignition or explosion, but one of the main causes is that, upon contact between the cathode and anode in the electrode assembly, a short-circuit current flows and reaches an abnormally high temperature, causing ignition or explosion. In other words, under normal circumstances, there should be insulation between the cathode and anode in the electrode assembly by a separator, but if the separator shrinks or breaks, a short circuit may occur as described above.

### SUMMARY OF THE INVENTION

According to one aspect of the present disclosure, an object of the present disclosure is to provide a secondary battery electrode assembly capable of securing insulation between a cathode and an anode in a manufacturing process of a secondary battery, and a manufacturing method of a secondary battery electrode assembly to manufacture the same.

According to another aspect of the present disclosure, an object of the present disclosure is to provide a secondary battery electrode assembly capable of improving stability of a secondary battery in a manufacturing process of a secondary battery, and a manufacturing method of a secondary battery electrode assembly to manufacture the same.

According to another aspect of the present disclosure, an object of the present disclosure is to provide a secondary battery electrode assembly capable of improving a manufacturing process efficiency of a secondary battery in a manufacturing process of a secondary battery, and a manufacturing method of a secondary battery electrode assembly to manufacture the same.

The secondary battery electrode assembly and the manufacturing method of a secondary battery electrode assembly to manufacture the same according to the present disclosure may be widely applied in the fields of electric vehicles, battery charging stations, energy storage systems (ESS), and other green technologies such as photovoltaics and wind power utilizing battery cells.

Furthermore, the secondary battery electrode assembly and the manufacturing method of a secondary battery electrode assembly to manufacture the same according to the present disclosure may be used in eco-friendly mobility, including electric vehicles and hybrid vehicles to prevent climate change by suppressing air pollution and greenhouse fluid emissions.

The present disclosure relates to an electrode assembly in which a plurality of electrode plates each including an uncoated portion and a coated portion and a plurality of separators are alternately stacked and which includes a plurality of tabs each protruding to one or both sides from the uncoated portion, wherein the plurality of tabs are aligned to overlap each other to form a converging tab bundle, and the tab bundle includes a gel cured portion.

In an embodiment, the plurality of tabs of the present disclosure may converge toward a thicknesswise center of the electrode assembly.

In an embodiment, the gel cured portion of the present disclosure may extend from an end region of the uncoated portion to a region where the plurality of tabs converge.

In an embodiment, the end region of the uncoated portion of the present disclosure may be spaced apart by a predetermined distance from a boundary of the uncoated portion and the coated portion.

In an embodiment, the gel cured portion of the present disclosure may include a plurality of uncoated ends and a plurality of tabs.

In an embodiment, the electrode assembly of the present disclosure may further include a connection at which an end of the tab bundle and an end of an electrode lead are joined, wherein the gel cured portion may extend to the connection.

In an embodiment, the gel cured portion of the present disclosure may be formed by curing a gel composition that is sprayed onto the tap bundle.

In an embodiment, the gel cured portion of the present disclosure may be formed by curing a gel composition that is sprayed onto the tab bundle and the connection.

In an embodiment, the gel cured portion of the present disclosure may have ion conductivity.

In an embodiment, the gel composition of the present disclosure may include a curable compound, an organic solvent, and a polymerization initiator.

In an embodiment, the curable compound of the present disclosure may include a thermopolymerizable monomer.

In an embodiment, the curable compound of the present disclosure may include a UV-curable monomer.

Also disclosed herein is a manufacturing method of an electrode assembly, the method including: transporting an electrode assembly in which a plurality of electrode plates each including an uncoated portion and a coated portion and a plurality of separators are alternately stacked and which includes a plurality of tabs each protruding to one or both sides from the uncoated portion; forming a tab bundle in which a plurality of tabs are aligned to overlap each other and converge; introducing the electrode assembly into an apparatus including a guide member to spray a gel composition onto the tab bundle; and curing the gel composition.

In other embodiments, the guide member of the present disclosure may have a slit formed in a portion corresponding to the tab bundle.

In another embodiment, the curing of the present disclosure may be performed by thermal drying.

In another embodiment, the curing of the present disclosure may be performed by ultraviolet irradiation.

According to one embodiment of the present disclosure, it is possible to secure insulation between the pole plates of a secondary battery.

According to another embodiment of the present disclosure, it is possible to enhance stability of a secondary battery.

According to another embodiment of the present disclosure, a manufacturing process efficiency in a manufacturing process of a secondary battery may be improved.

According to another embodiment of the present disclosure, folding or tearing of tabs in a manufacturing process of a secondary battery may be prevented.

According to another embodiment of the present disclosure, it is possible to prevent the tab from breaking due to expansion of a secondary battery in the use of the secondary battery.

### BRIEF DESCRIPTION OF THE DRAWINGS

FIG. 1 is a perspective view schematically illustrating an electrode assembly according to one embodiment of the present disclosure.

FIG. 2 is a schematic diagram schematically illustrating a side view of an electrode assembly according to one embodiment of the present disclosure.

FIG. 3 is an image schematically illustrating an electrode assembly according to one embodiment of the present disclosure.

FIG. 4 is a schematic diagram schematically illustrating a side view of an electrode assembly according to another embodiment of the present disclosure.

FIG. 5 is a schematic diagram schematically illustrating a manufacturing method of an electrode assembly according to another embodiment of the present disclosure.

### DETAILED DESCRIPTION

Hereinafter, embodiments of the present disclosure will be described in detail with reference to the accompanying drawings to facilitate practice by those of ordinary skill in the art to which the present disclosure pertains. However, the present disclosure may be implemented in various other forms and is not limited to the embodiments set forth herein. In order to clearly illustrate the present disclosure in the drawings, parts irrelevant to the description have been omitted, and like reference numerals throughout the specification refer to like elements.

As used herein, the term "secondary battery" refers to a battery cell or cell, which may be a jelly-roll type secondary battery wound with an electrode assembly stacked in a cathode plate/separator/anode plate structure on an exterior material of laminated sheets and embedded in connection with electrode tabs formed on the outside of the electrode assembly. Further, the tabs of the electrodes may be drawn outwardly of the sheet but extend in the same or opposite directions to each other.

Further, as used herein, the secondary battery includes a rechargeable cell, a battery cell, a cell, or a battery.

Furthermore, the secondary battery as used herein may include a cylindrical, prismatic, or pouch type battery, depending on the type of exterior materials.

Hereinafter, with reference to the following drawings, an electrode assembly 1 of a secondary battery and a manufacturing method thereof will be described in more detail in accordance with various embodiments of the present disclosure.

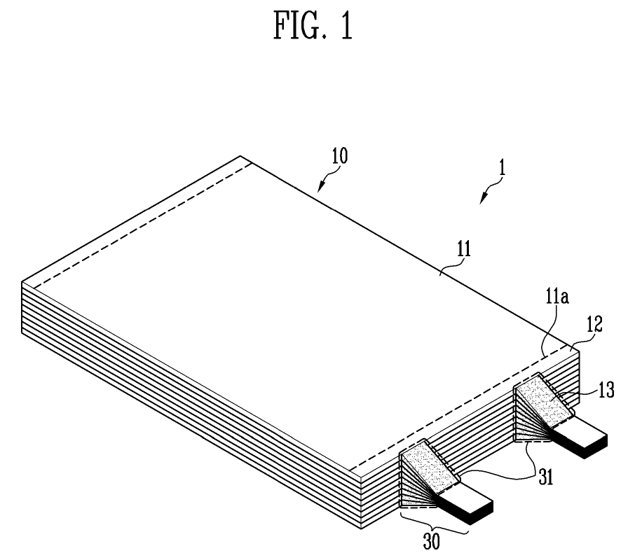

FIG. 1 is a perspective view schematically illustrating an electrode assembly 1 according to one embodiment of the present disclosure.

In one embodiment of the present disclosure, the electrode assembly 1 may have a plurality of electrode plates 10 each including an uncoated portion 12 and a coated portion 11 and a plurality of separators 20 alternately stacked, and include a plurality of tabs 13 each protruding to one or both sides from the uncoated portion 12. Further, the plurality of tabs 13 may be aligned to overlap each other to form a converging tab bundle 30.

For example, the electrode assembly 1 may be provided with a unit stack rolled in a square shape including thin plate-like or rod-like electrode plates 10 and a separator 20 interposed therebetween, or by stacking a plurality of unit stacks. If the electrode assembly 1 is formed by stacking, the long sides of the plurality of unit stacks may be arranged to be adjacent to each other.

In the electrode assembly 1 according to one embodiment of the present disclosure, the plurality of electrode plates 10 may be provided, wherein, of the plurality of electrode plates 10, a first electrode plate may be an anode, and a second electrode plate may be a cathode. Alternatively, they may be configured in reverse.

For example, in the case that the first electrode plate is an anode plate, the first electrode plate may be formed by applying a first electrode active material, such as graphite or carbon, to a first electrode collector provided in a metal foil, such as copper, copper alloy, nickel, or nickel alloy. The first electrode plate may have a first uncoated portion, which is a region to which no first electrode active material is applied. The first uncoated portion may be defined as a first tab, as it acts as a tab electrically connected to one of a plurality of collectors (not shown) that may be located on one side of the electrode assembly 1 in either direction. The plurality of first tabs may be aligned to one side to form a first tab bundle.

For example, in the case that the second electrode plate is a cathode plate, the second electrode plate may be formed by applying a second electrode active material, such as a transition metal oxide, to a second electrode collector provided as a metal foil, such as aluminum or aluminum alloy. The second electrode plate may have a second uncoated portion, which is a region where the second electrode active material is not applied. The second uncoated portion may be disposed on opposite sides of the electrode assembly 1 described above in both directions, and may serve as a tab electrically connected to another one of the plurality of collectors (not shown) described above, such that the second uncoated portion may be defined as a second tab. The plurality of second tabs may be aligned to one side to form a second tab bundle.

For example, a separator 20 may be located between the first electrode plate and a second electrode plate to prevent shorting and allow for the migration of lithium ions. For example, the separator 20 may be used by stacking a porous polymeric film alone, or stacking the films, wherein the porous polymeric film is prepared using a polyolefin-based polymer, such as an ethylene homopolymer, a propylene homopolymer, an ethylene/butene copolymer, an ethylene/hexene copolymer, an ethylene/methacrylate copolymer, or the like. As another example, in the separator 20, a conventional porous nonwoven fabric, for example, a nonwoven fabric made of glass fibers with a high melting point, polyethylene terephthalate fibers, or the like, may be used.

In one embodiment of the present disclosure, the electrode assembly 1 may be housed in a case or pouch (not shown) with an electrolyte. In some examples, the electrolyte may include a lithium salt, such as LiPF6 and LiBF4, in an organic solvent, such as ethylene carbonate (EC), propylene carbonate (PC), diethyl carbonate (DEC), ethylmethyl carbonate (EMC), and dimethyl carbonate (DMC). Further, the electrolyte may be liquid or gel phase. In some embodiments, the electrolyte may be omitted when an inorganic solid electrolyte is used.

Referring now to FIG. 1, the electrode plate 10 includes a coated portion 11 on which the electrode active material is applied. Furthermore, both ends of the coated portion 11 include the uncoated portion 12 on which no electrode active material is applied, and a tab 13 protruding from the uncoated portion 12 is not applied with the electrode active material.

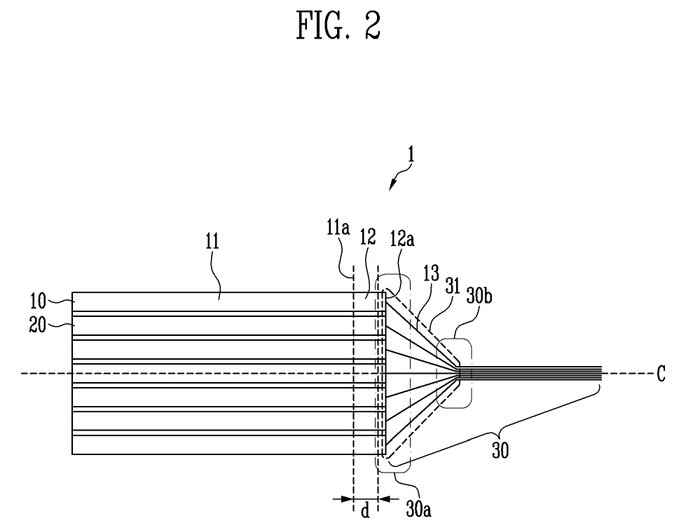

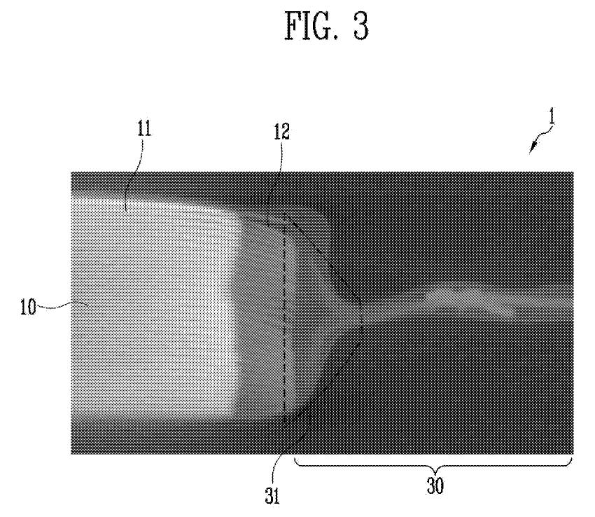

FIG. 2 is a schematic diagram schematically illustrating a side view of an electrode assembly 1 according to one embodiment of the present disclosure. FIG. 3 is an image schematically illustrating the electrode assembly 1 according to one embodiment of the present disclosure.

In one embodiment of the present disclosure, the plurality of tabs 13 may be aligned to overlap each other to form a converging tab bundle 30, wherein the plurality of tabs 13 forming the tab bundle 30 may converge toward a thicknesswise center C of the electrode assembly 1.

Furthermore, in one embodiment of the present disclosure, the tab bundle 30 may include a gel cured portion 31, which may extend from an end region 30a of the uncoated portion 12 to a region 30b where the plurality of tabs 13 converge. Thus, in one embodiment of the present disclosure, the gel cured portion 31 may include an end 12a of a plurality of uncoated portions 12 and the plurality of tabs 13.

As shown in FIGS. 2 and 3, the electrode assembly 1 may be formed of a plurality of electrode plates 10 and a plurality of separators 20 stacked on top of each other. The plurality of electrode plates 10 may be one or more of an anode plate and a cathode plate with different polarities, and the plurality of electrode plates 10 may be stacked in a way that the anode plate and the cathode plate with different polarities intersect. Further, the separator 20 may be stacked between the cross-stacked anode plate and cathode plate to separate the anode plate and cathode plate.

Further, the plurality of electrode plates 10 are each formed to have tabs 13 extending therefrom for electrical connection with electrode leads (not shown). For example, of the plurality of electrode plates 10, a cathode tab may be formed on the cathode plate, and an anode tab may be formed on the anode plate.

As shown in FIG. 2, the plurality of tabs 13 converge toward a thicknesswise center C of the electrode assembly 1. Further, a gel cured portion 31 in which the gel composition is cured may extend from the end region 30a of the uncoated portion 12 to the region 30b where the plurality of tabs 13 converge.

Furthermore, the end region 30a of the uncoated portion 12 is spaced apart by a predetermined distance d from the boundary 11a of the uncoated portion 12 and the coated portion 11, so that the gel cured portion 31 may include end regions 12a of the plurality of uncoated portion 12 and the plurality of tabs 13.

In one embodiment of the present disclosure, the gel cured portion 31 may have ion conductivity. For example, the uncoated portion 12 may be welded to the respective cathode and anode electrode leads. Typically, these welds are not fixed, which may cause the tabs 13 to break and fold due to external impact, with a risk of contact with the opposing electrode plates. In addition, the welding area is subject to high heat, which may easily cause venting upon thermal propagation.

Therefore, insulation between the cathode/anode plates may be secured by polymerizing the end 12a of the uncoated portion 12 of the electrode plate 10 and the tab bundle 30, and deformation due to external impact is suppressed by forming the gel cured portion 31 capable of immobilizing the tab bundle 30 of the electrode plate 10, thereby securing safety from internal short circuit and fire.

However, since the general polymer matrix composition becomes solid upon curing, the ion conductivity is low, and it is difficult to secure battery performance. Therefore, in one embodiment of the present disclosure, the gel cured portion 31 may be formed with a polymer having ion conductivity. For example, the ionically conductive polymer may include any polymer that is soluble in organic solvents and curable by heat or ultraviolet (UV) light along with a polymerization initiator.

In one embodiment of the present disclosure, the gel composition may include a curable compound, an organic solvent, and a polymerization initiator.

For example, a polymeric composition in a viscous liquid state may be formed by mixing an organic solvent, a carbonate-based electrolyte: a curable compound, an ionically conductive polymeric monomer: a polymerization initiator in a ratio of 60:39.6:0.4.

For example, in the case that the content ratio of the polymeric monomer is low, it is difficult to form a gel phase even when the curable composition is cured. Furthermore, in the case that the content ratio of the polymeric monomer is high, the viscosity of the gel composition becomes high, so that the flowability of the composition is poor, such that it may not be easy to move the gel composition into the space around the tap 13, while some of the gel composition may remain between the electrode plates 10 during movement.

Further, in one embodiment of the present disclosure, it is desirable that the gel composition is viscous. For example, in the case that the gel has a low viscosity, there is a risk that the gel composition will run down along the uncoated portion before it is cured upon spraying. Therefore, it is preferred that the gel composition has a viscosity of at least 2 mPa-s, which is the minimum viscosity condition for the gel composition not to run down when sprayed.

For example, the gel composition remaining between the electrode plates 10 has a large ionic conduction resistance compared to a liquid electrolyte, which may result in an increase in the internal resistance of the electrode assembly 1.

In one embodiment of the present disclosure, the gel cured portion 31 may be formed by curing the gel composition that is sprayed onto the tap bundle 30.

Specifically, once the liquid gel composition is cured by irradiation with heat, ultraviolet light, or an E-beam, the gel cured portion 31 may extend from the end region 30a of the uncoated portion 12 to a region 30b where the plurality of tabs 13 converge.

For example, the gel composition according to other embodiments of the present disclosure may utilize a gel electrolyte per se which is a conductive polymeric material, or a mixture of a gel electrolyte and a conductive polymeric material. This may reduce the interfacial resistance with the polymeric material, as the monomer solution prior to polymerization may cause swelling of the polymeric material, allow sufficient penetration into the polymeric material, and then undergo gelation by the polymerization reaction.

For example, since the gel composition according to one embodiment of the present disclosure has the property of a solution and is in the form of a gel, movement with anions and cations is facilitated in the same way as a conventional electrolyte, such that polarization and the like hardly occur compared to a case where a conventional polymeric material is used.

In one embodiment of the present disclosure, the curable compound may include a thermopolymerizable monomer or a UV-curable monomer.

For example, the monomer solution may be trimethylolpropane ethoxylate triacrylate, polyethylene glycol dimethacrylate, polyvinyl formal, trimethylolpropane ethoxylate triacrylate, and the like.

For example, one or more of tetraethylene glycol diacrylate, poly ethylene glycol diacrylate (molecular weight 50-20,000), 1,4-butanediol diacrylate, 1,6-hexandiol diacrylate, trimethylolpropane triacrylate, trimethylolpropane ethoxylate triacrylate, trimethylolpropane propoxylate triacrylate, ditrimethylolpropane tetraacrylate, pentaerythritol tetraacrylate, pentaerythritol ethoxylate tetraacrylate, dipentaerythritol pentaacrylate, dipentaerythritol hexaacrylate, poly(ethylene glycol) diglycidylether, 1,5-hexadiene diepoxide, glycerol propoxylate triglycidyl ether, vinylcyclohexene dioxide, 1,2,7,8-diepoxyoctane, 4-vinylcyclohexene dioxide, butyl glycidyl ether, diglycidyl 1,2-cyclohexanedicarboxylate, ethylene glycol diglycidyl ether, glycerol triglycidyl ether, and glycidyl methacrylate may be used as the thermopolymerizable monomers.

For example, one or more of octyl/decyl acrylate (ODA), isodecyl acrylate (IDA), lauryl acrylate (LA), stearyl acrylate (SA), phenoxyethyl acrylate (PEA), nonyl phenol ethoxylate monoacrylate (MNPEOA), tetrahydrofurfuryl acrylate, cyclohexyl acrylate, 4-butylcyclohexyl acrylate, dicyclopentenyl acrylate, dicyclopentenyl oxyethylacrylate, 4-hydroxybutyl acrylate (4-HBA), and phenoxyethyl acrylate may be used as the UV-curable monomer.

For example, as for the polymerization initiator, a thermopolymerization initiator or a photopolymerization initiator may be used, depending on the type of curable compound.

For example, in the case that a thermopolymerizable monomer is used as the curable compound, the thermopolymerization initiator may be used as the polymerization initiator. Also, in the case that a UV-curable monomer is used as the curable compound, the photopolymerization initiator may be used as the polymerization initiator.

For example, the thermopolymerization initiator may be decomposed under heat to form radicals, which may react with the monomer or polymerizable monomer, by free radical polymerization, to gelate the gel composition. For example, the thermaopolymerization initiator may be decomposed by heat in a cell, such as heat at 30°C to 100°C, as a non-limiting example, or at room temperature (5°C to 30°C) to form radicals, and the polymerizable monomer may form the gel composition by free radical polymerization.

For example, a photopolymerization initiator may be decomposed by light to form radicals, which may react with the monomer or polymerizable monomer to gelate the gel composition by free radical polymerization.

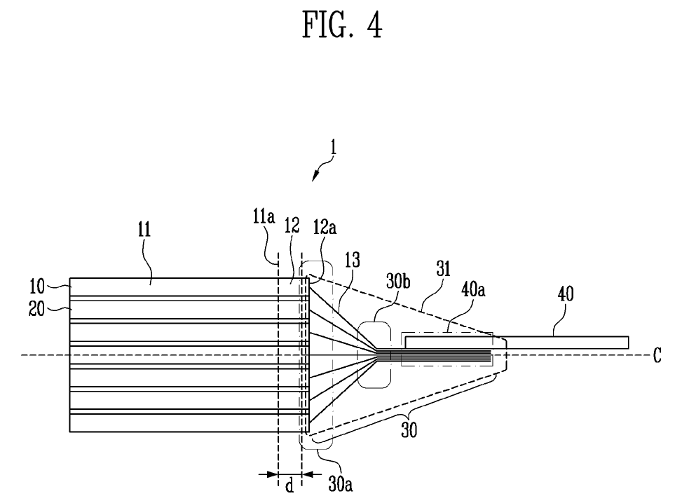

FIG. 4 is a schematic diagram schematic illustrating a side view of an electrode assembly 1 according to another embodiment of the present disclosure.

The electrode assembly 1 according to another embodiment of the present disclosure may further include a connection 40a where an end of the tab bundle 30 and an end of the electrode lead 40 are joined, and the gel cured portion 31 may extend to the connection 40a.

For example, as shown in FIG. 4, the electrode assembly 1 according to another embodiment of the present disclosure may further include an electrode lead 40 that may be coupled to an end of the tab bundle 30. For example, the electrode leads 40 may be an electrically conductive metal. Although not shown, the electrode leads 40 may include a cathode lead connected with a tab bundle on the cathode side and an anode lead connected with a tab bundle on the anode side. For example, the electrode leads 40 may be connected to the tab bundle 30 at the connection 40a in a variety of ways, such as by welding. For example, the other end of the electrode leads 40 may be disposed to be exposed to the outside of the case (not shown) of the electrode assembly 1.

In other words, the electrode leads 40 may serve as electrode terminals of the electrode assembly 1, for example, the cathode lead may serve as a cathode terminal of the electrode assembly 1, and the anode lead may serve as an anode terminal of the electrode assembly 1.

In another embodiment of the present disclosure, the gel cured portion 31 may be formed by curing of a gel composition sprayed onto the tap bundle 30 and the connection 40a. Thus, as shown in FIG. 4, the gel cured portion 31 may extend to surround the connection 40a.

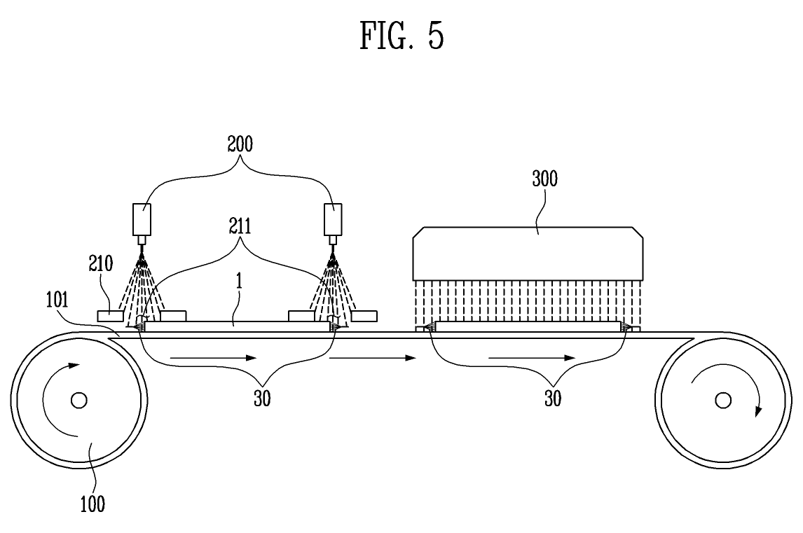

FIG. 5 is a schematic diagram schematically illustrating a manufacturing method of an electrode assembly 1 according to another embodiment of the present disclosure.

In another embodiment of the present disclosure, the manufacturing method of an electrode assembly 1 of the present disclosure may include: transferring an electrode assembly 1 in which a plurality of electrode plates 10 each including an uncoated portion 12 and a coated portion 11 and a plurality of separators 20 alternately stacked and which includes a plurality of tabs each protruding to one or both sides from the uncoated portion 12; forming a tab bundle 30 in which a plurality of tabs are aligned to overlap each other and converge; introducing the electrode assembly 1 into an apparatus including a guide member 210 to spray a gel composition onto the tab bundle 30; and curing the gel composition.

As shown in FIG. 5, the electrode assembly 1 may be unwound from a transfer roller 100 and moved at a constant speed on a conveyor 101, and the electrode assembly 1 may be drawn into a lower portion of a spraying device 200 to spray the gel composition onto the tab bundle 30, which may be disposed at either end of the electrode assembly 1.

In other embodiments of the present disclosure, the gel composition may be gel-cured by thermal drying, or the gel may be cured by ultraviolet irradiation.

As shown in FIG. 5, the electrode assembly 1 with the spraying of the gel composition onto the tab bundle 30 completed may be transferred to a curing device 300, which is located in the next line in the spaying device 200.

For example, the curing device 300 may be a drying device or an ultraviolet irradiation device, and for example, if the curing device 300 is a drying device, the gel composition sprayed onto the tap bundle 30 may be cured by thermal drying. Also, for example, in the case that the curing device 300 is an ultraviolet irradiation device, the gel composition sprayed onto the tab bundle 30 may be cured by irradiating ultraviolet light.

For example, the electrode assembly 1 may be continuously moved on the conveyor 101 at a rate of 1 to 30 m/min, or at a rate of 1 to 10 m/min, so that the process may be performed continuously in-line.

In another embodiment of the present disclosure, the guide member 210 may have a slit 211 formed in a portion corresponding to the tab bundle 30 of the electrode assembly 1.

As shown in FIG. 5, through the slit 211 or opening formed in the guide member 210, the gel composition may be applied only to the tab bundles 30 of the electrode assembly 1.

For example, the guide member 210 may be in the form of a mask with the portion to be coated formed by the slit 211 or opening. For example, it may be a planar mask made of a polymer material in which the slits 211 or openings are formed. Further, the width of the slit 211 or opening may be determined by the area of the gel cured portion 31 to be formed.

For example, the guide member 210 may be designed to be disposed at a position or height in contact with the electrode plate 10 to minimize the migration of the gel composition sprayed from a spray to the lateral side of the tab bundle 30 in the electrode assembly 1, i.e., to adjacent electrode plates.

For example, in the case that the guide member 210 is made of metal, as the electrode assembly 1 moves, the electrode plates 10 of the electrode assembly 1 may come in contact with and rub against the guide member 210, causing scratches to the coated portion 11 on the surface, such that it is desirable that the guide member 210 is made of a polymeric material.

The scope of the present disclosure is indicated by the following claims rather than by the detailed description above, and the meaning and scope of the claims and any modification or variation derived from the equivalents thereof are to be construed as being within the scope of the present disclosure.

What is claimed is:

1. An electrode assembly, in which a plurality of electrode plates each including an uncoated portion and a coated portion and a plurality of separators are alternately stacked and which includes a plurality of tabs each protruding to one or both sides from the uncoated portion,
wherein the plurality of tabs are aligned to overlap each other to form a converging tab bundle, and
the tab bundle includes a gel cured portion.

2. The electrode assembly according to claim 1, wherein the plurality of tabs converge toward a thicknesswise center of the electrode assembly.

3. The electrode assembly according to claim 1, wherein the gel cured portion extends from an end region of the uncoated portion to a region where the plurality of tabs converge.

4. The electrode assembly according to claim 1,
wherein the end region of the uncoated portion is spaced apart by a predetermined distance from a boundary of the uncoated portion and the coated portion.

5. The electrode assembly according to claim 4, wherein the gel cured portion includes a plurality of uncoated ends and a plurality of tabs.

6. The electrode assembly according to claim 5, further comprising a connection at which an end of the tab bundle and an end of an electrode lead are joined,
wherein the gel cured portion extends to the connection.

7. The electrode assembly according to claim 1, wherein the gel cured portion is formed by curing a gel composition that is sprayed onto the tap bundle.

8. The electrode assembly according to claim 5, wherein the gel cured portion is formed by curing a gel composition that is sprayed onto the tab bundle and the connection.

9. The electrode assembly according to claim 7, wherein the gel cured portion has ion conductivity.

10. The electrode assembly according to claim 7, wherein the gel composition includes a curable compound, an organic solvent, and a polymerization initiator.

11. The electrode assembly according to claim 10, wherein the curable compound includes a thermopolymerizable monomer.

12. The electrode assembly according to claim 10, wherein the curable compound includes a UV-curable monomer.

13. A manufacturing method of an electrode assembly, the method comprising:
transporting an electrode assembly in which a plurality of electrode plates each including an uncoated portion and a coated portion and a plurality of separators are alternately stacked and which includes a plurality of tabs each protruding to one or both sides from the uncoated portion;
forming a tab bundle in which a plurality of tabs are aligned to overlap each other and converge;
introducing the electrode assembly into an apparatus including a guide member to spray a gel composition onto the tab bundle; and
curing the gel composition.

14. The manufacturing method according to claim 13, wherein the guide member has a slit formed in a portion corresponding to the tab bundle.

15. The manufacturing method according to claim 13, wherein the curing is performed by thermal drying.

16. The manufacturing method according to claim 13, wherein the curing is performed by ultraviolet irradiation.
